(19) United States
(12) Patent Application Publication
(10) Pub. No.: US 2014/0298243 A1
(43) Pub. Date: Oct. 2, 2014

(54) ADJUSTABLE GUI FOR DISPLAYING INFORMATION FROM A DATABASE

(71) Applicant: Alcatel-Lucent USA Inc., Murray Hill, NJ (US)

(72) Inventors: Son Le, Santa Ana, CA (US); Timothy Norman, Oak Ridge, NC (US)

(73) Assignee: Alcatel-Lucent USA Inc., Murray Hill, NJ (US)

(21) Appl. No.: 13/853,516

(22) Filed: Mar. 29, 2013

(51) Int. Cl. G06F 3/0481

(52) U.S. Cl. CPC G06F 3/0481
USPC 715/780

(57) ABSTRACT

The system includes a memory and a processing system. The memory stores a GUI template, the GUI template including information identifying data fields and indicating locations for the data fields on a screen. The processing system is able to display the data fields identified by the GUI template on the screen at the locations indicated by the GUI template, to retrieve a record from a database, and to populate the data fields on the screen with data from the record. The processing system is further able to move a data field to a new location on the screen based on input from a user while the data field is populated with data from the record, and to update a location for the data field indicated by the GUI template to specify the new location.

### FIELD OF THE INVENTION

The invention relates to the field of Graphical User Interfaces (GUIs) for data retrieval systems.

### BACKGROUND

Existing data retrieval systems use screens (e.g., digital displays) to present data from records of a database. As a part of this process, the data retrieval systems access information stored in one or more GUI templates. The information in a GUI template is used in order to determine the nature and location of graphic and/or textual items on-screen. For example, one GUI template may describe locations for a set of textual data fields used to display contact information for a selected employee, while another GUI template may describe locations for radio buttons, drop boxes, and text fields used for selecting a product and displaying information about a product. When GUI templates are used, information from each record pulled from a database can be formatted in the same way when it is displayed to a user via a screen.

In existing data retrieval systems, each GUI template is pre-defined in memory before the system comes online. When the system initializes, it also loads GUI templates stored in memory. When the system is being used to display information from a database, the GUI templates cannot be altered. Changing the GUI templates may require a specialized offline editing tool, and in some cases may require re-compiling the entire system. Thus, when a database serves multiple customers that each prefer to view data in a different format, the process of defining customized GUI templates for each customer may be an extremely time-consuming process.

### SUMMARY

Embodiments described herein provide systems having GUI templates that can be manipulated during run-time in order to meet a user's specifications. Furthermore, changing each GUI template at run-time does not require a reboot or otherwise interrupt access to the database.

One exemplary embodiment is a system that includes a memory and a processing system. The memory stores a GUI template, the GUI template including information identifying data fields and indicating locations for the data fields on a screen. The processing system is able to display the data fields identified by the GUI template on the screen at the locations indicated by the GUI template, to retrieve a record from a database, and to populate the data fields on the screen with data from the record. The processing system is further able to move a data field to a new location on the screen based on input from a user while the data field is populated with data from the record, and to update a location for the data field indicated by the GUI template to specify the new location.

In another embodiment, moving the data field to the new location changes the position of the data field relative to other data fields on the screen.

In another embodiment, the processing system is further able to receive user input clicking on the data field, dragging the data field, and releasing the data field. Also, the processing system is further able to determine the new location based on where the user input drags the data field.

In another embodiment, the memory stores GUI templates for multiple users, and the processing system is further able to identify a user accessing the database, and to select a GUI template based on the identity of the user.

In another embodiment, the processing system is further able, while the data fields on the screen are populated with data from the record, to move the data field to a new location overlapping another data field.

In another embodiment, the processing system is further able to update the GUI template with information identifying a new data field, while the data fields on the screen are populated with data from the record.

In another embodiment, the database is located on a remote server, and the processing system is further able to access the database at the remote server via a network.

Another embodiment comprises a method. The method includes identifying a Graphical User Interface (GUI) template stored in memory, the GUI template including information identifying data fields and indicating locations for the data fields on a screen. The method also includes displaying the data fields identified by the GUI template on the screen at the locations indicated by the GUI template, retrieving a record from a database, and populating the fields on the screen with data from the record. Further, the method includes moving a data field to a new location on the screen based on input from a user while the data field is populated with data from the record, and updating a location for the data field indicated by the GUI template to specify the new location.

Another embodiment comprises a non-transitory computer readable medium storing programmed instructions which, when executed by a processor, are able to perform a method. The method includes identifying a Graphical User Interface (GUI) template stored in memory, the GUI template including information identifying data fields and indicating locations for the data fields on a screen. The method also includes displaying the data fields identified by the GUI template on the screen at the locations indicated by the GUI template, retrieving a record from a database, and populating the fields on the screen with data from the record. Further, the method includes moving a data field to a new location on the screen based on input from a user while the data field is populated with data from the record, and updating a location for the data field indicated by the GUI template to specify the new location.

Other exemplary embodiments (e.g., methods and computer-readable media relating to the foregoing embodiments) may be described below.

### DESCRIPTION OF THE DRAWINGS

Some embodiments of the present invention are now described, by way of example only, and with reference to the accompanying drawings. The same reference number represents the same element or the same type of element on all drawings.

FIG. 1 is a block diagram of a data retrieval system in an exemplary embodiment.

FIG. 2 is a flowchart illustrating a method for operating a data retrieval system in an exemplary embodiment.

FIG. 3 is a block diagram of a screen used for a data retrieval system in an exemplary embodiment.

FIG. 4 is a block diagram of a GUI template used to generate the screen of FIG. 3 in an exemplary embodiment.

FIG. 5 is a block diagram illustrating a data field of a screen that is dragged and dropped to a new location at runtime in an exemplary embodiment.

FIG. 6 is a block diagram of a GUI template having revised information stored for the screen of FIG. 5 in an exemplary embodiment.

FIG. 7 is a block diagram of a screen that has been revised during run-time to display new data fields in an exemplary embodiment.

FIG. 8 is a block diagram of a GUI template having revised information stored for the screen of FIG. 7 in an exemplary embodiment.

FIG. 9 illustrates a processing system operable to execute a computer readable medium embodying programmed instructions to perform desired functions in an exemplary embodiment.

### DETAILED DESCRIPTION

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention, and are to be construed as being without limitation to such specifically recited examples and conditions. As a result, the invention is not limited to the specific embodiments or examples described below, but by the claims and their equivalents.

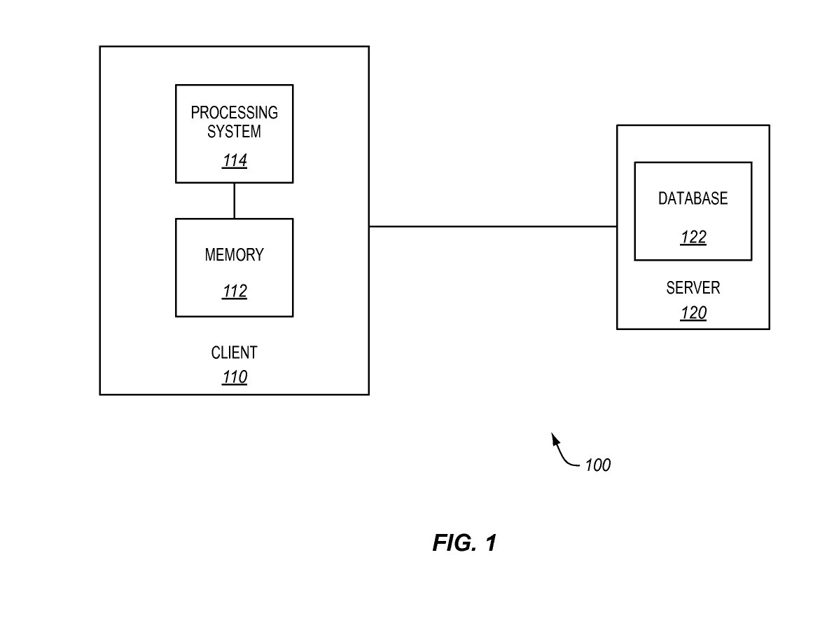

FIG. 1 is a block diagram of a data retrieval system 100 in an exemplary embodiment. Data retrieval system 100 comprises any system, device, or component operable to populate a screen (e.g., a digital display at client 110) with information from a database. For example, a user may access data retrieval system 100 in order to retrieve and display information from database records that describe employees of a company.

In this embodiment, data retrieval system 100 includes one or more clients 110 that are coupled with server 120 (e.g., via a network). Each client 110 accesses records stored on database 122 of server 120, and presents information from these records to a user via a screen. The information from the records is formatted on the screen based on information from a GUI template stored in memory 112. More particularly, the GUI template indicates which specific data from a record is displayed at the screen. The GUI template also indicates where data from a record is placed within a screen (e.g., using an absolute location, or, a relative location with respect to other data). Specifically, the GUI template describes multiple data fields that are placed at defined locations on the screen. Each data field is used to display specific types of information from a selected database record.

When the user selects a new record from the database, processing system 114 populates the data fields on the screen with information for the new record as indicated by the GUI template. Processing system 114 may be implemented, for example, as custom circuitry, as a special or general purpose processor executing programmed instructions stored in an associated program memory, or some combination.

Data retrieval system 100 has been enhanced to allow a user to alter the location of data fields on the screen at run-time, while client 110 is presenting information from database 122 to a user. Furthermore, when the location of a data field has been altered, the GUI template can also be revised to reflect the change in location. This provides substantial benefit over prior systems because it allows a user to dynamically organize data on the fly.

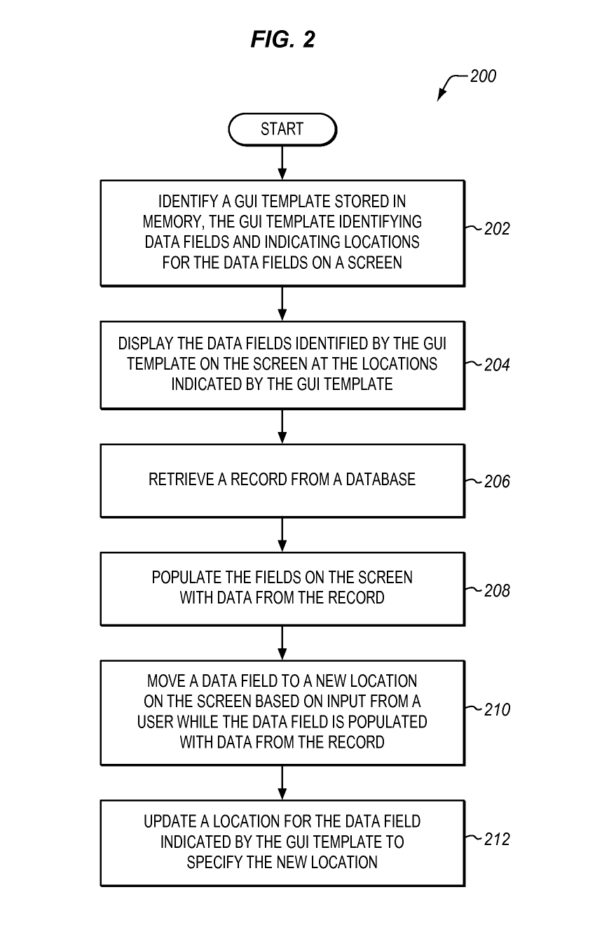

Further details of the operation of data retrieval system 100 will be discussed with regard to FIG. 2. Assume, for this embodiment, that processing system 114 utilizes client 110 to access database 122. Further, assume that memory 112 currently stores one or more GUI templates for use by client 110.

FIG. 2 is a flowchart illustrating a method 200 for operating a data retrieval system in an exemplary embodiment. The steps of method 200 are described with reference to data retrieval system 100 of FIG. 1, but those skilled in the art will appreciate that method 200 may be performed in other systems. The steps of the flowcharts described herein are not all inclusive and may include other steps not shown. The steps described herein may also be performed in an alternative order.

In step 202, processing system 114 identifies a GUI template stored in memory 112 (e.g., based on the identity of a user of client 110). A GUI template includes information that describes a set of data fields, labels, and/or controls that are placed on a screen (e.g., in a graphical window) and used to display information from a database. For example, a GUI template may describe textual and numeric data fields for displaying information for records of a database. A GUI template further indicates locations on a screen to place each of these data fields. A GUI template may further describe the nature and location of labels, controls such as drop-down menus and input fields for selecting new database records, etc. A GUI template itself may be stored in memory 112 as a set of instructions.

Once a GUI template has been identified, processing system 114 processes the GUI template and displays each of the data fields identified by the GUI template on a screen in step 204. Each data field is placed on the screen at a location indicated by the GUI template. For example, processing system 114 may review the information stored in the GUI template to determine a format for the data field (e.g., text, numeric, etc.), a location for the data field (e.g., an X and Y position relative to a corner of the window), a size for the data field (e.g., a length and a width), and a link for the data field. The link defines what information from a record is used to populate the data field. For example, a textual data field for “name” may have a link pointing to a <LAST NAME> portion of a database record.

Once the data fields have been shown on the screen, a user may select a record within database 122 for viewing. When a record has been selected, processing system 114 retrieves the record from database 122 in step 206. This may comprise sending a request to the database that specifically identifies the record, and then receiving the record from server 120. The record may then be copied into memory 112 to allow for faster access by client 110.

In step 208, processing system 114 populates the data fields on the screen to display information from the record to the user (e.g., via a monitor). This allows the user to review and interpret the information stored in the record. The populated data fields on the screen are displayed to the user (e.g., within a “window”). Steps 204-208 may be repeated multiple times in order for a user to select and view information from multiple records one after the other.

As information from a record is being viewed and displayed, the user may prefer to re-arrange the way that the data from each record is being shown on-screen. For example, in a database for products, the user may attempt to visually correlate shipping addresses with delivery complaints, in order to determine whether certain delivery regions are regularly experiencing shipping delays. Therefore, the user may prefer to move a delivery address field on the screen closer to a shipping complaints field. This helps the user to visually correlate shipping complaints with delivery addresses.

In step 210, processing system 114 moves one or more data fields on the screen to a new location based on the user preference input, while the data field is still populated with data from a record of the database. The new location for the data field is changed with respect to the other data fields. This changes the overall look of the screen, re-arranging the way that it appears in accordance with the user's preference. Thus, even though the screen is being used to actively view data from a database, the data fields can be moved in order to perform analytics (or for aesthetic purposes) as desired by the user. The user's preferences with respect to new locations for the data fields on the screen can then be updated at the GUI template in memory 112 (or server 120) for later retrieval in step 212, in case the user wishes to use a similar on-screen arrangement again at a later time.

Method 200 exhibits enhanced visual flexibility over prior systems. This enhanced flexibility is beneficial because it allows each user to view database records in the way that they prefer. At the same time, this flexibility does not require that data retrieval system 100 (or its clients 110) be taken offline in order to generate new or revised GUI templates.

### EXAMPLES

In the following examples, additional processes, systems, and methods are described in the context of a data retrieval system that alters GUI templates while information from a record in a database is being shown on-screen.

Assume, for this example, that a user is operating a client 110 in order to access records stored on database 122. Client 110 identifies the user based on their login name, and requests one or more GUI templates from a remote server 120 via a network. The specific GUI templates requested are determined based on the identity and/or preferences of the user (e.g., based on their login name, position within the company, etc.). Server 120 transmits the requested GUI templates to client 110, and also transmits a copy of database 122. The GUI templates and the copy of database 122 are then loaded into memory 112 by processing system 114, so that client 110 may view information from database records and manipulate GUI templates without occupying bandwidth for server 120. Once a GUI template has been processed, data fields identified by the GUI template are presented to the user via a screen at client 110. Information from database records may then be accessed from memory 112 and displayed on the screen (i.e., by populating the on-screen data fields with information from selected records).

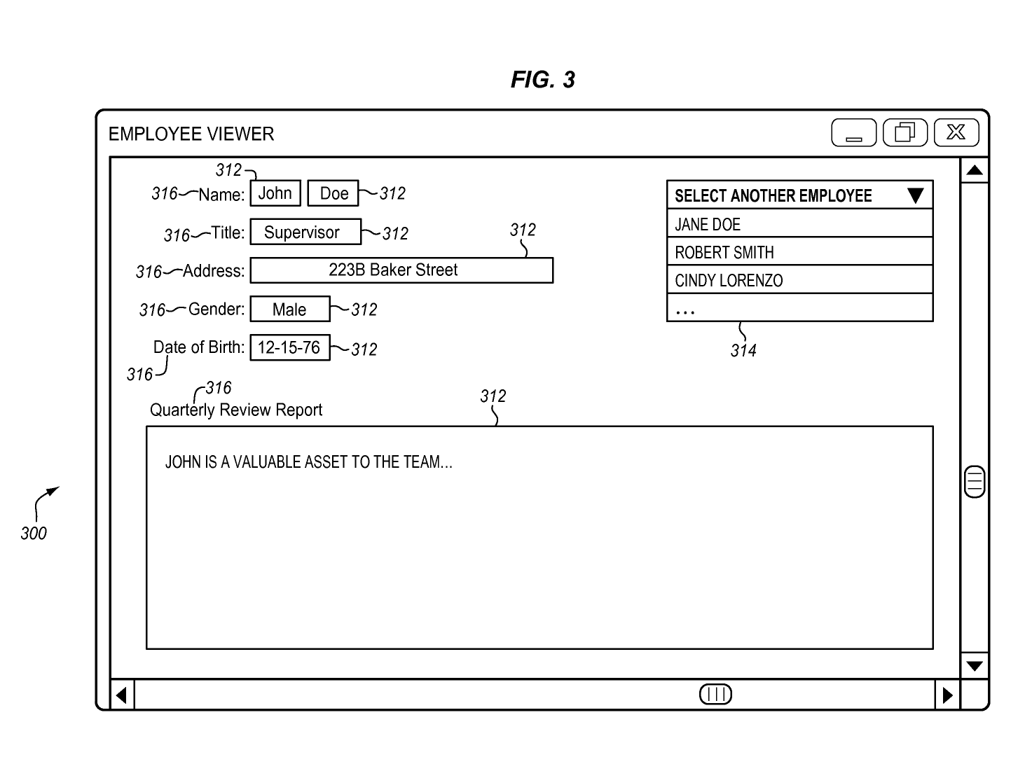

FIG. 3 is a block diagram 300 of a screen used for a data retrieval system in an exemplary embodiment. The screen displays labels 316, data fields 312, and drop-down menu 314. Labels 316 identify the type of data that is being displayed to a user. Data fields 312 display information pulled from records within database 122. Drop-down menu 314 is a control that allows a user to select new employee records, and is sorted alphabetically based on employee last name. Drop-down menu 314 is merely one example of the numerous types of controls that could be implemented on the screen to select or alter database records.

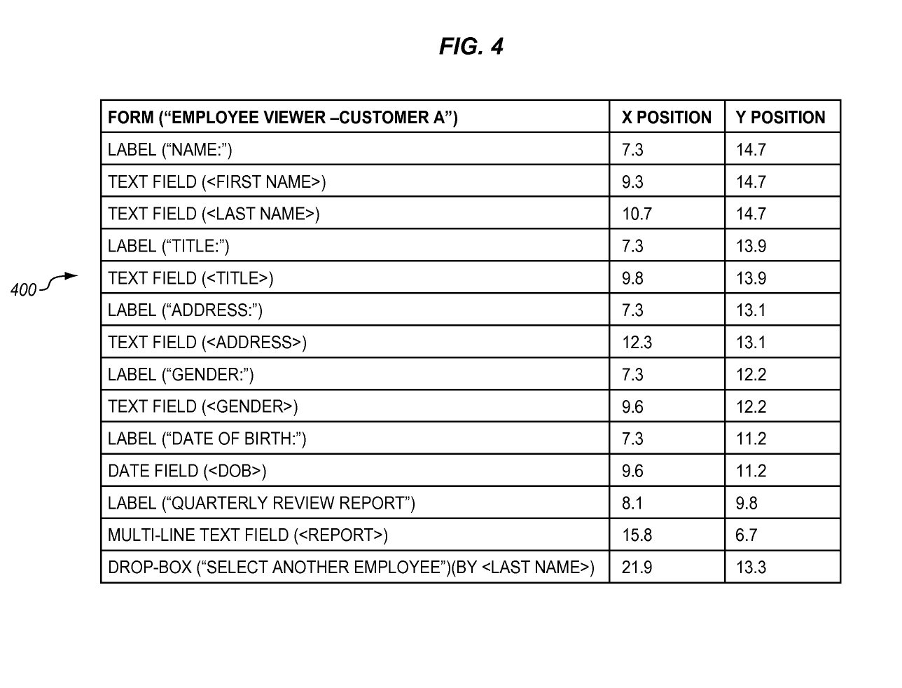

FIG. 4 is a block diagram 400 of a GUI template used to generate the screen of FIG. 3 in an exemplary embodiment. According to FIG. 4, information describing each label, data field, and control is stored for the GUI template in memory 112. The information includes a specific X and Y position for each label, data field, and control relative to the upper left corner of the screen (or a “window” thereof), as well as a width and height (not shown). For data fields and certain controls, the information also includes a link. A link (e.g., <FIRST NAME>) describes what information from a database record to use to populate a data field. In one embodiment, the name of the link identifies a corresponding part of the record (e.g., the part or field of the record that corresponds to the link). This information in FIG. 4 is used by processing system 114 at run-time to display information on the screen, which enables client 110 to display the records from database 122. For example, processing system 114 may utilize information from the links to generate Structured Query Language (SQL) queries for a SQL database.

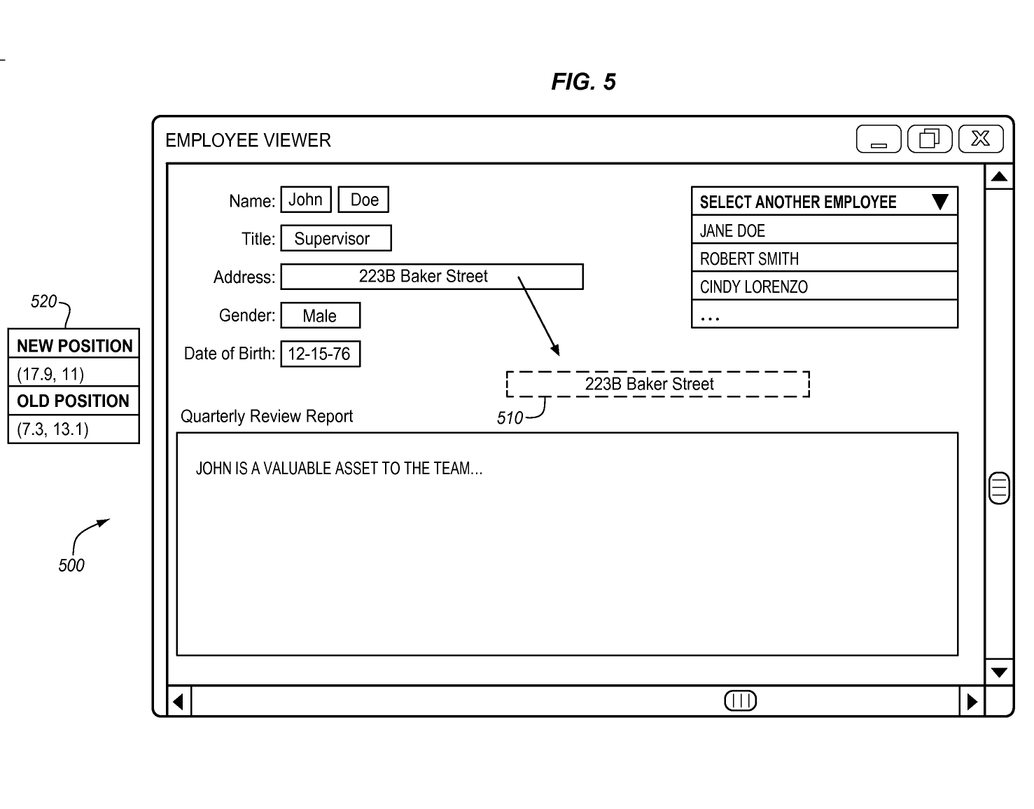

FIG. 5 is a block diagram 500 illustrating a data field of a screen that is dragged and dropped to a new location at runtime in an exemplary embodiment. Here, a user clicks on data field 510, and drags data field 510 to a new location indicated with the dashed outline as per the user's preference. While data field 510 is being dragged, processing system 114 tracks the current and original (e.g., starting) location of data field 510 in memory 112, as shown at numeral 520. Once data field 510 is released by the user, the data field 510 is placed at the new location on the screen by processing system 114. Additionally, information in the GUI template is updated to reflect the change to the location of field 510. Note that, according to FIG. 5, when data field 510 is moved to the new location, its position relative to other data elements on the screen has been changed, which may also be stored in the GUI template.

In one embodiment, processing system 114 initiates the drag and drop process by detecting a click from a mouse pointer at the same position as an existing data field. Then, processing system 114 anchors a corner of the data field to the mouse pointer. As the mouse pointer is dragged, the data field is also dragged. In a further embodiment, a label for the data field may be dragged along with the data field, at a fixed proximity to the data field.

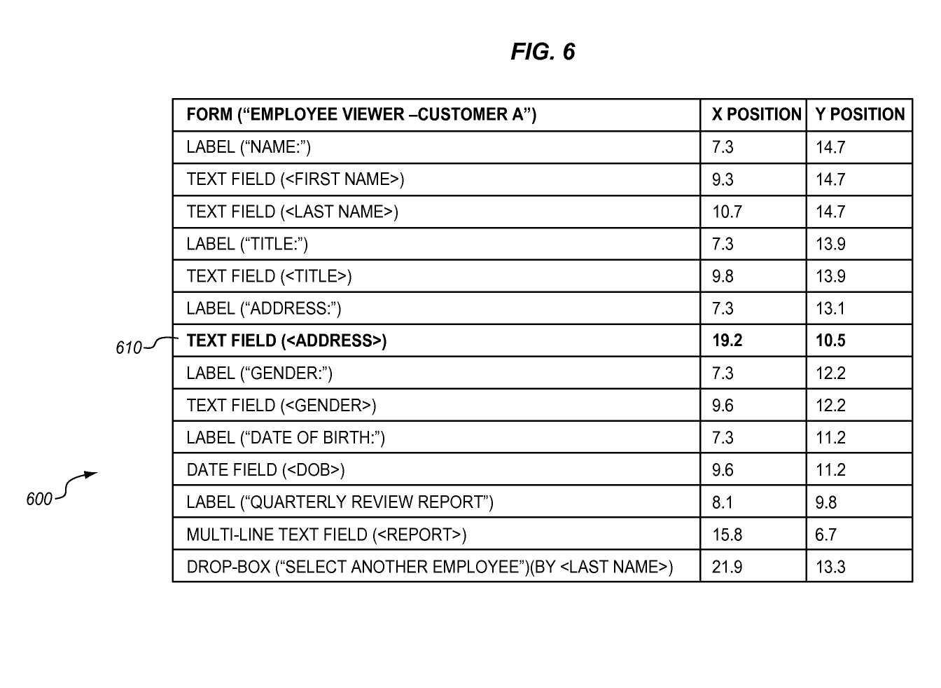

FIG. 6 is a block diagram 600 of a GUI template having revised information stored for the screen of FIG. 5 in an exemplary embodiment. According to FIG. 6, entry 610, which indicates the location of field 510, has been updated to indicate the new location.

In one embodiment, the GUI template defines a unique numbered layer for each label, data field, and control. The labels, data fields, and controls can be dragged anywhere on the screen. When the labels, data fields, and/or controls overlap each other, the one with the highest numbered layer is displayed in front of the other on the screen. In a further embodiment, whenever a label, data field, or control is being dragged by a user, it is moved to the highest layer so that it will appear on top of anything that overlaps it. In accordance with these aspects, the user may also assign the unique numbered layers to some or all of the labels, data fields, and controls according to the user's preferences.

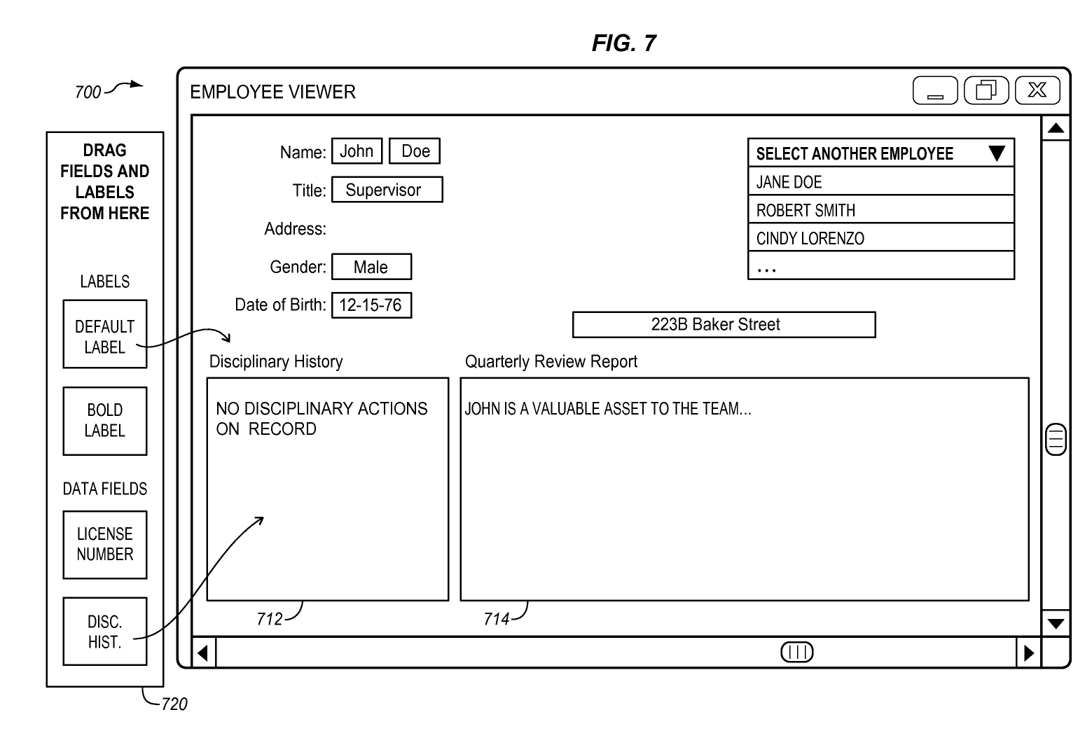

After field 510 has been moved, the user also inserts a new data field onto the screen. FIG. 7 is a block diagram 700 of a screen that has been revised during run-time to display a new data field in an exemplary embodiment. According to FIG. 7, a user has opened a palette 720 that includes many data fields, labels, and controls that may be dragged and dropped into the screen of FIG. 5. Palette 720 is generated based on information stored in memory 112 that describes which data fields are presently available. This information stored in memory 112 may describe what each available data field looks like, any appropriate links for data fields, sizes for data fields, and/or other properties.

In this example, palette 720 includes a placeholder graphic for each data field that is available. The data fields that are available and presented to the user may be determined based on the information (e.g., fields) from one or more records stored in the database). When the placeholder graphic for a data field is dragged to a location and released, memory 112 is accessed to determine the name of the corresponding data field (as well as to determine a link for the data field). The data field is then placed on the screen and populated with corresponding data from the current record, and a GUI template for the screen is updated to include the new data field at its current location on the screen. The information in memory 112 that describes each available data field, label, and/or control may be pre-programmed into memory 112, or may be dynamically determined based on the contents of the database.

In this example, the user has selected a placeholder graphic from palette 720 (for a field named “disciplinary history”), and has dragged the placeholder graphic from palette 720 to a location on the screen. The disciplinary history data field is then added to the screen once the placeholder graphic is released, and is shown here as a multi-line textual data field on the screen. Additionally in FIG. 7, the user has dragged a default label onto the screen, and has updated the text for the default label to state “Disciplinary History.” As a part of adding the new data field, the user has also changed the location of a data field 714 that previously existed within the GUI template. Based on these changes, the GUI template is updated in memory 112.

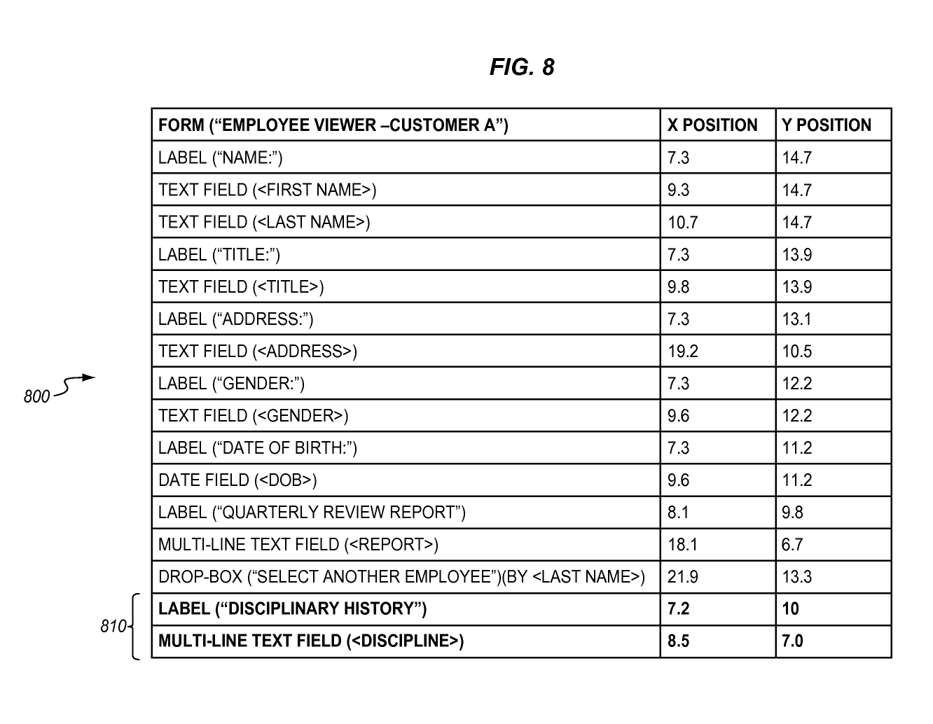

FIG. 8 is a block diagram of a GUI template 800 having revised information stored for the screen of FIG. 7 in an exemplary embodiment. In FIG. 8, the changes made to the GUI template are stored in memory 112 as the user changes the screen (the changes are shown in bold at numeral 810) based on the user's preferences. These changes to the GUI template can then be pushed out to server 120 and saved as the user's preferences as desired. Alternatively, a user can choose to not save the changes that they have made. In this case, the changes to the GUI template are not saved to server 120, and are therefore lost after the user logs out of client 110.

In a further embodiment, a user may use an interface such as palette 720 to dynamically construct a screen from scratch. In such cases, a blank screen may be generated, and an empty GUI template may be created for the screen in memory 112. The user may then add various labels, data fields, and controls onto the screen based on, for example, data stored in one or more records. As each data field is added, it may be populated with corresponding data from a selected record. The user may periodically save the locations of the labels, data fields, and controls shown on the screen by updating the GUI template. The GUI template may additionally be saved to memory in server 120 if desired.

Any of the various components shown in the figures or described herein may be implemented as hardware, software, firmware, or some combination of these. For example, a component may be implemented as dedicated hardware. Dedicated hardware elements may be referred to as “processors,” “controllers,” or some similar terminology. However, explicit use of the term “processor” or “controller” should not be construed to refer exclusively to hardware capable of executing software.

A component may also be implemented as instructions executable by a processor or a computer to perform the functions of the component. Some examples of instructions are software, program code, and firmware. The instructions when executed by the processor may configure the processor to perform the functions of the component. The instructions may be stored on storage devices that are readable by the processor. Some examples of the storage devices are digital or solid-state memories, magnetic storage media such as a magnetic disks and magnetic tapes, hard drives, or optically readable digital data storage media.

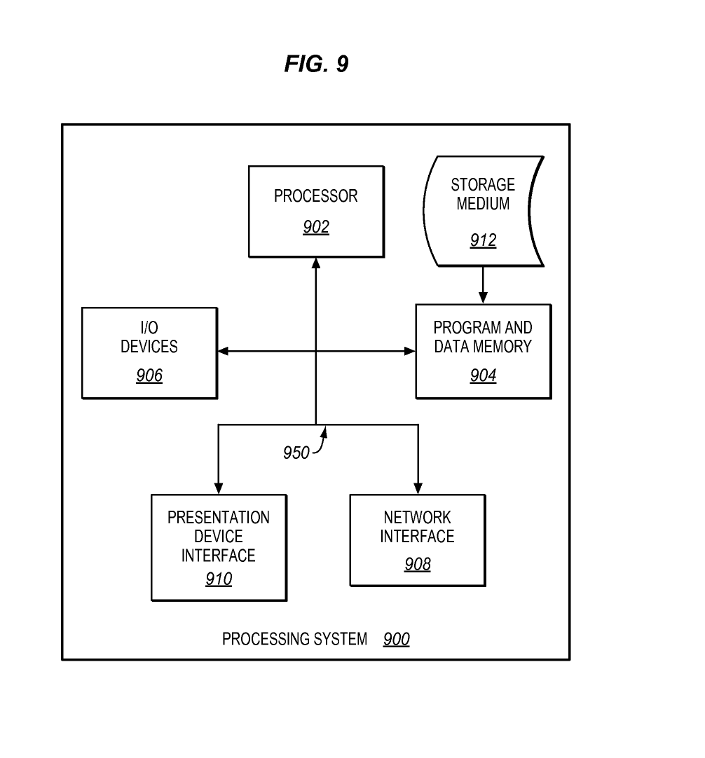

In one embodiment, the processing system 114 may execute a software application or program, which, upon execution, configures the processing system 114 to perform the various operations disclosed herein. FIG. 9 illustrates an exemplary processing system 900 operable to execute program instructions stored on a computer readable medium. Processing system 900 is operable to perform the above operations by executing programmed instructions stored on computer readable storage medium 912. In this regard, embodiments of the invention can take the form of a computer program accessible via computer readable medium 912 providing program code for use by a computer (e.g., processing system 900) or any other instruction execution system. For the purposes of this description, computer readable storage medium 912 can be anything that can contain or store the program for use by the computer (e.g., processing system 900).

Computer readable storage medium 912 can be an electronic, magnetic, optical, electromagnetic, infrared, or semiconductor device. Examples of computer readable storage medium 912 include a solid state memory, a magnetic tape, a removable computer diskette, a random access memory (RAM), a read-only memory (ROM), a rigid magnetic disk, and an optical disk. Current examples of optical disks include compact disk - read only memory (CD-ROM), compact disk-read/write (CD-R/W), and DVD.

Processing system 900, being suitable for storing and/or executing the program code, includes at least one processor 902 coupled to program and data memory 904 through a system bus 950. Program and data memory 904 can include local memory employed during actual execution of the program code, bulk storage, and cache memories that provide temporary storage of at least some program code and/or data in order to reduce the number of times the code and/or data are retrieved from bulk storage during execution.

Input/output or I/O devices 906 (including but not limited to keyboards, displays, pointing devices, etc.) can be coupled with other components of processing system 900 either directly or through intervening I/O controllers. Network adapter interfaces 908 may also be integrated with the system to enable processing system 900 to become coupled to other data processing systems or storage devices through intervening private or public networks. Modems, cable modems, IBM Channel attachments, SCSI, Fibre Channel, and Ethernet cards are just a few of the currently available types of network or host interface adapters. Presentation device interface 910 may be integrated with the system to interface to one or more presentation devices, such as printing systems and displays for presentation of presentation data generated by processor 902.

Although specific embodiments were described herein, the scope of the invention is not limited to those specific embodiments. The scope of the invention is defined by the following claims and any equivalents thereof.

1. A system comprising:
a memory storing a Graphical User Interface (GUI) template, the GUI template including information identifying data fields and indicating locations for the data fields on a screen; and
a processing system operable to display the data fields identified by the GUI template on the screen at the locations indicated by the GUI template, to retrieve a record from a database, and to populate the data fields on the screen with data from the record,
the processing system further operable to move a data field to a new location on the screen based on input from a user while the data field is populated with data from the record, and to update a location for the data field indicated by the GUI template to specify the new location.

2. The system of claim 1 wherein:
moving the data field to the new location changes the position of the data field relative to other data fields on the screen.

3. The system of claim 1 wherein:
the processing system is further operable to receive user input clicking on the data field, dragging the data field, and releasing the data field, and
the processing system is further operable to determine the new location based on where the user input drags the data field.

4. The system of claim 1 wherein:
the memory stores GUI templates for multiple users, and
the processing system is further operable to identify a user accessing the database, and to select a GUI template based on the identity of the user.

5. The system of claim 1 wherein:
the processing system is further operable, while the data fields on the screen are populated with data from the record, to move the data field to a new location overlapping another data field.

6. The system of claim 1 wherein:
the processing system is further operable to update the GUI template with information identifying a new data field, while the data fields on the screen are populated with data from the record.

7. The system of claim 1 wherein:
the database is located on a remote server, and
the processing system is further operable to access the database at the remote server via a network.

8. A method comprising:
identifying a Graphical User Interface (GUI) template stored in memory, the GUI template including information identifying data fields and indicating locations for the data fields on a screen;
displaying the data fields identified by the GUI template on the screen at the locations indicated by the GUI template;
retrieving a record from a database;
populating the fields on the screen with data from the record;
moving a data field to a new location on the screen based on input from a user while the data field is populated with data from the record; and
updating a location for the data field indicated by the GUI template to specify the new location.

9. The method of claim 8 wherein:
moving the data field to the new location changes the position of the data field relative to other data fields on the screen.

10. The method of claim 8 further comprising:
receiving user input clicking on the data field, dragging the data field to a new location, and releasing the data field; and
determining the new location based on where the user input drags the data field.

11. The method of claim 8 wherein:
the memory stores GUI templates for multiple users, and the method further comprises:
identifying a user accessing the database; and
selecting a GUI template based on the identity of the user.

12. The method of claim 8 further comprising:
moving the data field to a new location overlapping another data field while the data fields on the screen are populated with data from the record.

13. The method of claim 8 further comprising:
updating the GUI template with information identifying a new data field, while the data fields on the screen are populated with data from the record.

14. The method of claim 8 wherein:
the database is located on a remote server, and the method further comprises:
accessing the database at the remote server via a network.

15. A non-transitory computer readable medium storing programmed instructions which, when executed by a processor, are operable for performing a method comprising:
identifying a Graphical User Interface (GUI) template stored in memory, the GUI template including information identifying data fields and indicating locations for the data fields on a screen;
displaying the data fields identified by the GUI template on the screen at the locations indicated by the GUI template;
retrieving a record from a database;
populating the fields on the screen with data from the record;
moving a data field to a new location on the screen based on input from a user while the data field is populated with data from the record; and
updating a location for the data field indicated by the GUI template to specify the new location.

16. The medium of claim 15 wherein:
moving the data field to the new location changes the position of the data field relative to other data fields on the screen.

17. The medium of claim 15 wherein the method further comprises:
receiving user input clicking on the data field, dragging the data field to a new location, and releasing the data field; and
determining the new location based on where the user input drags the data field.

18. The medium of claim 15 wherein:
the memory stores GUI templates for multiple users, and the method further comprises:
identifying a user accessing the database; and
selecting a GUI template based on the identity of the user.

19. The medium of claim 15 wherein the method further comprises:
moving the data field to a new location overlapping another data field while the data fields on the screen are populated with data from the record.

20. The medium of claim 15 wherein the method further comprises:
updating the GUI template with information identifying a new data field, while the data fields on the screen are populated with data from the record.
